(19) United States
(12) Patent Application Publication
(10) Pub. No.: US 2025/0232545 A1
(43) Pub. Date: Jul. 17, 2025

(54) STABLE PLANE ESTIMATION METHOD AND SYSTEM FOR PLACING OBJECT IN STABLE POSTURE

(71) Applicant: GWANGJU INSTITUTE OF SCIENCE AND TECHNOLOGY, Gwangju (KR)

(72) Inventors: Kyoobin LEE, Gwangju (KR); Rae Young KANG, Gwangju (KR); Tae Won KIM, Gwangju (KR); Sang Jun NOH, Gwangju (KR); Seung Hyeok BACK, Gwangju (KR); Seong Ho BAK, Gwangju (KR)

(73) Assignee: GWANGJU INSTITUTE OF SCIENCE AND TECHNOLOGY, Gwangju (KR)

(21) Appl. No.: 19/022,983

(22) Filed: Jan. 15, 2025

(30) Foreign Application Priority Data
Jan. 15, 2024 (KR) 10-2024-0006012

(51) Int. Cl. G06T 19/20; G06T 13/40

(52) U.S. Cl. CPC G06T 19/20; G06T 13/40; G06T 2219/2004; G06T 2219/2016

(57) ABSTRACT

A stable plane estimation method including acquiring a mesh for a target object, disposing a flat plate model, disposing the mesh above the flat plate model, and dropping the mesh disposed above the flat plate model toward the flat plate model, and sampling, as a stable plane an area in contact with the flat plate model among a plurality of points belonging to the mesh when the mesh dropped toward the flat plate model stops, to generate training data for an object controlled to be placed on a specific support surface.

### CROSS REFERENCE TO RELATED APPLICATION

The present application claims priority to Korean Patent Application No. 10-2024-0006012 filed on Jan. 15, 2024, the entire contents of which are incorporated herein for all purposes by this reference.

### STATEMENT REGARDING PRIOR DISCLOSURES BY THE INVENTOR OR A JOINT INVENTOR

Prior disclosure related to the present application was made by inventors of the present application in journal paper entitled “Learning to Place Unseen Objects Stably using a Large-scale Simulation” on Mar. 15, 2023. A copy of the journal paper is provided on an Information Disclosure Statement filed concurrently.

### BACKGROUND

### Field

The present invention relates to a stable plane estimation method and system for placing an object in a stable posture.

### Description of Government-Sponsored Research

The present invention was carried out with support from the national research and development project, with the unique project identification number being 1415184338 and the project number being 20008613. The project related to the present invention is supervised by the Ministry of Trade, Industry and Energy, and managed by the Korea Planning and Evaluation Institute of Industrial Technology (KEIT). The research program is titled “the Robot Industry Technology Development Project,” and the research project is named “Development of Shared Work Technology Based on Deep Reinforcement Learning that Can Intelligently Respond to Unstructured Work Environments such as Assembly Tasks.” The project executing institution is the Korea University (KU) Research and Business Foundation, and the research period is from Jan. 1, 2023, to Dec. 31, 2023.

### Description of the Related Art

Recently, research is being actively conducted in the manufacturing, construction, and various service fields on methods of grasping various objects and moving or manipulating the grasped objects using robots such as manipulators.

In particular, conventionally, robots have been controlled by detecting objects using various sensors such as cameras and generating a path to move the robot's arm to grasp the detected object.

In addition, in order for a robot to place a grasped object in a specific space, it is mainly used to recognize information on the specific space and control the robot's arm to a predetermined posture, such as the posture when grasping the object, to place the object.

### SUMMARY

The present invention relates to a method and system for estimating a stable plane of an object to place the object in a stable posture.

In addition, the present invention relates to a stable plane estimation method and system for sampling a stable plane for placing a target object in a stable posture based on a point cloud for the target object.

In addition, the present invention relates to a stable plane estimation method and system for sampling a stable plane by dropping meshes for various target objects on a flat plate model in virtual space.

In addition, the present invention relates to a stable plane estimation method and system for verifying a stable plane by rotating a flat plate model on which a mesh is dropped during a simulation process for sampling a stable plane for a target object in virtual space.

In order to achieve the above-described objects, according to an aspect of the present invention, a stable plane estimation method for placing an object in a stable posture, includes: acquiring a mesh for a target object; disposing a flat plate model, disposing the mesh above the flat plate model, and dropping the mesh disposed above the flat plate model toward the flat plate model; and sampling, as a stable plane, an area in contact with the flat plate model in the mesh when the mesh dropped toward the flat plate model stops, to generate training data for an object controlled to be placed on a specific support surface.

Moreover, according to another aspect of the present invention, a stable plane estimation system for placing an object in a stable posture, includes: an input unit configured to acquire a mesh for a target object; and a control unit configured to dispose a flat plate model, dispose the mesh above the flat plate model, and drop the mesh disposed above the flat plate model toward the flat plate model, in which the control unit samples, as a stable plane, an area in contact with the flat plate model in the mesh when the mesh dropped toward the flat plate model stops, to generate training data for an object controlled to be placed on a specific support surface.

According to still another aspect of the present invention, a program stored on a computer-readable recording medium and executed by one or more processors in an electronic device, includes instructions to execute: acquiring a mesh for a target object; disposing a flat plate model, disposing the mesh above the flat plate model, and dropping the mesh disposed above the flat plate model toward the flat plate model; and sampling, as a stable plane, an area in contact with the flat plate model in the mesh when the mesh dropped toward the flat plate model stops, to generate training data for an object controlled to be placed on a specific support surface.

In addition, according to still another aspect of the present invention, a stable plane estimation method for placing an object in a stable posture, includes: acquiring a point cloud for an object; inputting the point cloud into an artificial neural network trained using a pre-constructed training data set; and acquiring a stable plane in which the object is placed on a support surface in a stable posture from the artificial neural network, in which the trained artificial neural network acquires a learning mesh for a target object, drops the learning mesh onto a plane, samples an area in contact with the plane in the learning mesh as a learning stable plane, and is trained using the training data set including the learning mesh and the learning stable plane.

Moreover, according to still another aspect of the present invention, a stable plane estimation system for placing an object in a stable posture, includes: an input unit configured to acquire a point cloud for an object; and a control unit configured input the point cloud into an artificial neural network trained using a pre-constructed training data set and acquire a stable plane in which the object is placed on a support surface in a stable posture from the artificial neural network, in which the trained artificial neural network acquires a learning mesh for a target object, drops the learning mesh onto a plane, samples an area in contact with the plane in the learning mesh as a learning stable plane, and is trained using the training data set including the learning mesh and the learning stable plane.

In addition, according to still another aspect of the present invention, a program stored on a computer-readable recording medium and executed by one or more processors in an electronic device, includes instructions to execute: acquiring a point cloud for an object; inputting the point cloud into an artificial neural network trained using a pre-constructed training data set; and acquiring a stable plane in which the object is placed on a support surface in a stable posture from the artificial neural network, in which the trained artificial neural network acquires a learning mesh for a target object, drops the learning mesh onto a plane, samples an area in contact with the plane in the learning mesh as a learning stable plane, and is trained using the training data set including the learning mesh and the learning stable plane.

According to various embodiments of the present invention, the stable plane estimation method and system for placing an object in a stable posture can provide one side surface of an object for stably placing various objects in a predetermined space without human manipulation by specifying the stable plane for placing the target object in the stable posture based on the point cloud for the target object.

In addition, according to various embodiments of the present invention, the stable plane estimation method and system for placing an object in a stable posture can estimate stable planes for various objects that have not been trained in the past by dropping the meshes for various target objects onto a flat plate model in the virtual space to specify the stable plane, and can also generate large-scale training data for training the artificial neural network.

Through this, the stable plane estimation method and system for placing an object in a stable posture can sample the stable plane through a simulation for a target object whose stable plane has not been trained, and can also estimate a stable plane for an object whose stable plane has not been trained by using the artificial neural network trained with large-scale training data.

In addition, according to various embodiments of the present invention, the stable plane estimation method and system for placing an object in a stable posture can verify whether the stable plane specified for the target object acts as an actual stable plane under various conditions by rotating the flat plate model on which the mesh is dropped during a simulation process for specifying the stable plane for the target object in the virtual space, and can specify a more accurate stable plane for the target object.

### BRIEF DESCRIPTION OF THE DRAWINGS

FIG. 1 illustrates a stable plane estimation system for placing an object in a stable posture according to the present invention.

FIG. 2 is a flowchart illustrating a stable plane estimation method for placing an object in a stable posture according to the present invention.

FIGS. 3, 4A and 4B illustrate one embodiment of disposing a flat plate model and a mesh in a virtual space.

FIGS. 5A and 5B illustrates one embodiment of dropping the mesh toward the flat plate model.

FIGS. 6A, 6B, 7A and 7B illustrate one embodiment of verifying a stable plane.

FIGS. 8A and 8B illustrate one embodiment of a stable plane specified for a target object.

FIG. 9 is a flowchart illustrating another embodiment of the stable plane estimation method for placing an object in a stable posture according to the present invention.

FIG. 10 illustrates one embodiment of training an artificial neural network.

FIG. 11 illustrates one embodiment using the artificial neural network.

FIG. 12 is a block diagram illustrating a structure of a computing device (or a e electronic device) performing the input-dependent uncorrelated weighting method according to the present invention.

### DETAILED DESCRIPTION

Hereinafter, embodiments disclosed in the present specification will be described in detail with reference to the attached drawings, and identical or similar components will be given the same reference numerals regardless of the drawing symbols, and redundant descriptions thereof will be omitted. The suffixes “module” and “unit” used for components in the following description are given or used interchangeably only for the convenience of writing the specification, and do not have distinct meanings or roles in themselves. In addition, in a case of describing the embodiments disclosed in the present specification, when it is determined that a specific description of a related known technology may obscure the gist of the embodiments disclosed in the present specification, the detailed description thereof will be omitted. In addition, the attached drawings are only intended to facilitate easy understanding of the embodiments disclosed in the present specification, and the technical ideas disclosed in the present specification are not limited by the attached drawings, and should be understood to include all modifications, equivalents, or substitutes included in the spirit and technical scope of the present invention.

Terms including ordinal numbers such as first, second, or the like may be used to describe various components, but the components are not limited by the terms. The terms are used only for the purpose of distinguishing one component from another.

When a component is referred to as being “coupled” or “connected” to another component, it should be understood that it may be directly connected or connected to that other component, but there may also be other components in between. Meanwhile, when a component is referred to as being “directly coupled” or “directly connected” to another component, it should be understood that there are no other components therebetween.

The singular expression includes the plural expression unless the context clearly indicates otherwise.

In the present application, the terms “include” or “have” are intended to specify the presence of features, numbers, steps, operations, components, parts, or combinations thereof described in the specification, but should be understood not to preclude the possibility of the presence or addition of one or more other features, numbers, steps, operations, components, parts, or combinations thereof.

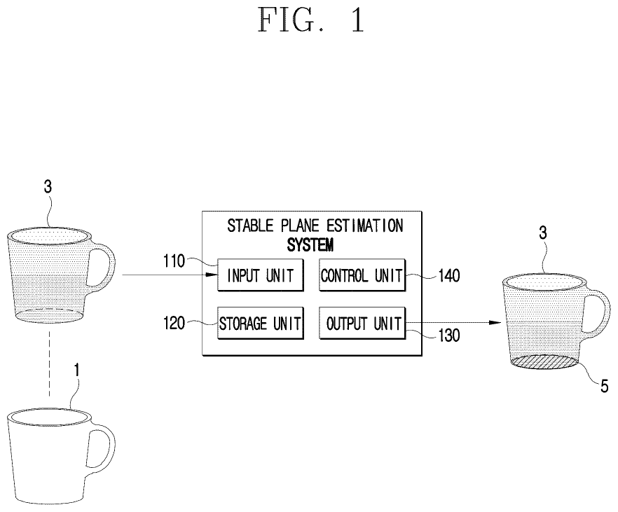

FIG. 1 illustrates a stable plane estimation system for placing an object in a stable posture according to the present invention.

Referring to FIG. 1, a stable plane estimation system 100 for placing an object in a stable posture according to the present invention may acquire a mesh for a target object 1, and drop the mesh on a flat plate model to sample (or specify) an area in contact with the flat plate model as a stable plane 5.

Accordingly, the stable plane estimation system 100 may construct a training data set based on a mesh for a target object 1 and a previously sampled stabile plane 5 and, using the constructed training data set, train an artificial neural network to output the stable plane 5 corresponding to an input point cloud 3 when the point cloud 3 for the target object 1 is input.

Here, the target object 1 (or, object) may include various objects existing in reality, and in one embodiment, may include an object that can be grasped and disposed (or, placed) using a manipulator.

In this case, the stable plane 5 may include one side surface of the object for stably placing (or disposing) the object on a predetermined support surface by the manipulator. That is, the stable plane 5 may include an area in contact with the flat plate model in a posture where the mesh of the target object 1 is stably placed on the predetermined flat plate model.

That is, the stable plane 5 may mean a surface on which the target object 1 can be disposed (or placed) on the support surface in a stable posture, and for example, when the target object 1 is a cup, the stable plane 5 may include a bottom surface, a surface forming a periphery of an inlet side, one side surface of a handle, and one side surface of the body of the cup. As another example, when the target object 1 is a hexahedral box-shaped object, the stable plane 5 may include each surface forming the hexahedron.

In this way, the stable plane 5 may be sampled to correspond to one side surface where the specific support surface and the object are in contact with each other when the object corresponding to the target object 1 maintains a stable posture on the specific support surface, and according to the embodiment, one or more stable planes 5 may be specified for one target object 1.

The mesh may be a three-dimensional model implemented in a three-dimensional virtual space to correspond to the target object 1. Such a mesh may include a vertex, an edge, and a face, and therefore, the stable plane 5 specified from the mesh may include a plurality of vertices or one or more edges or faces. According to an embodiment, the mesh may include a polygon mesh or a curved mesh.

In addition, the mesh may be implemented based on a point cloud corresponding to the target object 1, or may be prepared in advance to correspond to a predetermined target object 1. The point cloud 3 may include a plurality of points formed at different locations in a three-dimensional virtual space to correspond to a target object 1. This point cloud 3 may be generated based on a depth image captured using a depth camera, or may be generated based on a mesh model implemented in a three-dimensional virtual space.

That is, a plurality of points belonging to the point cloud 3 may be generated at each of a plurality of locations based on distance information belonging to the depth image in which the target object is captured, or may be generated at each of the plurality of locations according to vertices or polygons belonging to the mesh model.

The virtual space may be a virtual space that simulates physical phenomena that acts on a real space. That is, the virtual space may simulate various physical phenomena, such as gravity, the law of action-reaction, and friction, that acts on a target object 1 in a real space. Depending on the embodiment, the virtual space may be implemented as a three-dimensional simulation space based on a real space, or may be implemented as a space based on virtual reality (VR), augmented reality (AR), mixed reality (MR), and extended reality (XR).

Meanwhile, the stable plane estimation system 100 according to the present invention may acquire the stable plane 5 corresponding to the point cloud 3 through an artificial neural network trained using a pre-constructed training data set.

In such a case, the training data set may include the mesh for each of a plurality of different target objects 1 and one or more stable planes 5 specified for each mesh.

Therefore, the artificial neural network may be trained to output the stable plane 5 for a predetermined target object 1 (or point cloud 3) when the point cloud 3 for the predetermined target object 1 is input.

In one embodiment, the artificial neural network such as a dynamic graph convolutional neural network (DGCNN) may use a model which performs learning based on the neighboring relationships between the plurality of points belonging to the point cloud 3 when the point cloud 3 is input.

Meanwhile, the stable plane estimation system 100 according to the present invention may include an input unit 110, a storage unit 120, an output unit 130, and a control unit 140.

The input unit 110 may input the point cloud 3 for the target object 1. To this end, the input unit 110 according to one embodiment may receive a depth image captured by a depth camera, or the point cloud 3 generated from the depth image. Alternatively, in another embodiment, the input unit 110 may receive a mesh (or mesh model) corresponding to the target object 1, or the point cloud 3 generated by the mesh model. In another embodiment, the input unit 110 may be connected to a separately provided server or device via a wireless or wired network to receive the point cloud 3.

The storage unit 120 may store data and instructions necessary for the operation of the stable plane estimation system 100 according to the present invention. For example, the storage unit 120 may store the mesh, the point cloud 3, the stable plane 5 specified for the point cloud 3, or the like. In addition, the storage unit 120 may store the virtual space and data for implementing (or disposing) the mesh, the point cloud 3, and a predetermined flat plate model in the virtual space.

Additionally, the storage unit 120 may store the artificial neural network trained to estimate the stable plane 5 from the point cloud 3.

The output unit 130 may output the stable plane 5 specified for the target object 1 through a display screen. In addition, the output unit 130 may also output a scene in which a simulation is performed in the virtual space to specify the stable plane 5 from the point cloud 3 for the target object 1.

The control unit 140 may control the overall operation of the stable plane estimation system 100 according to the present invention. For example, the control unit 140 may generate the point cloud 3 using the depth image, the mesh model, or the like.

In addition, the control unit 140 may perform a simulation to dispose the predetermined flat plate model and the mesh in the virtual space and drop the mesh toward the predetermined flat plate model to specify the stable plane 5.

Additionally, the control unit 140 may input the point cloud 3 into the artificial neural network to acquire the stable plane 5 corresponding to the point cloud 3.

Based on the configuration of the stable plane estimation system 100 described above, a stable plane estimation method will be described in more detail below.

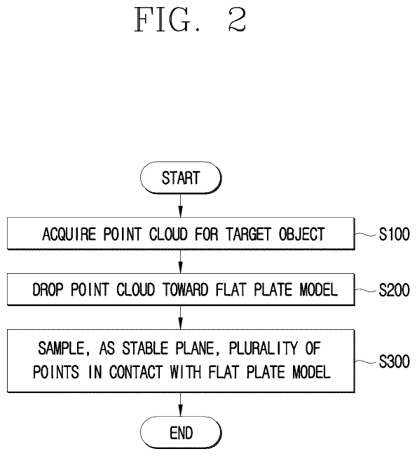

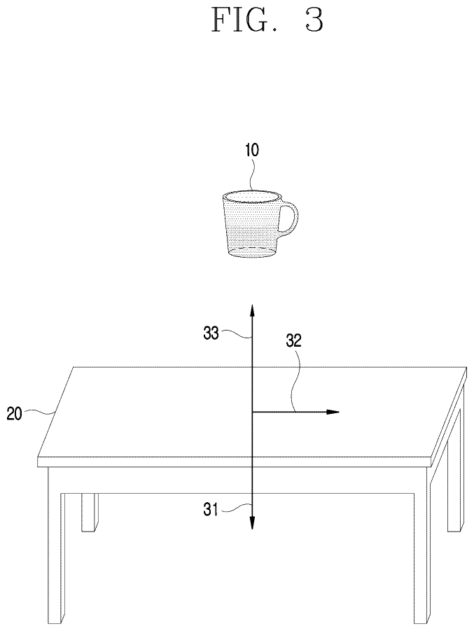

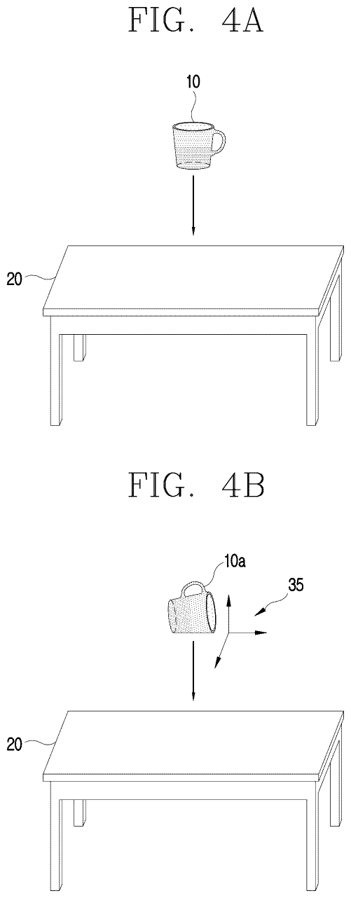

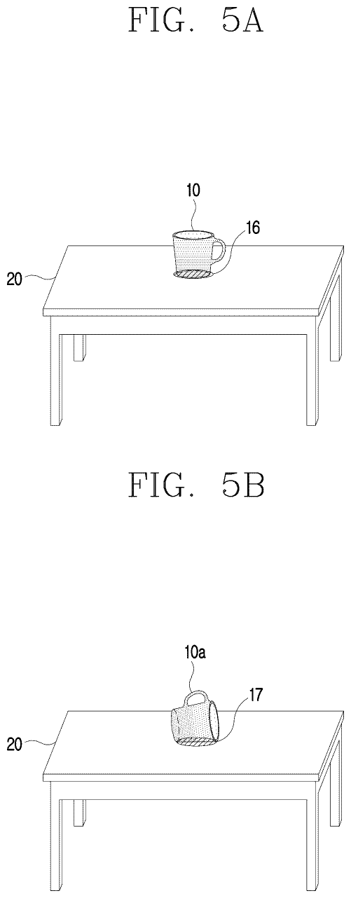

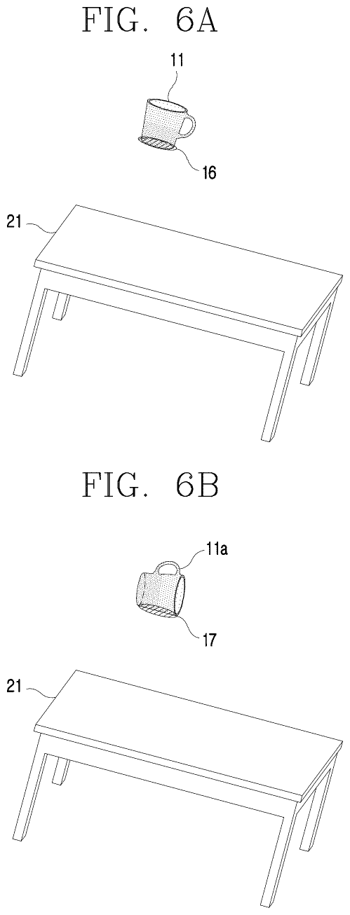

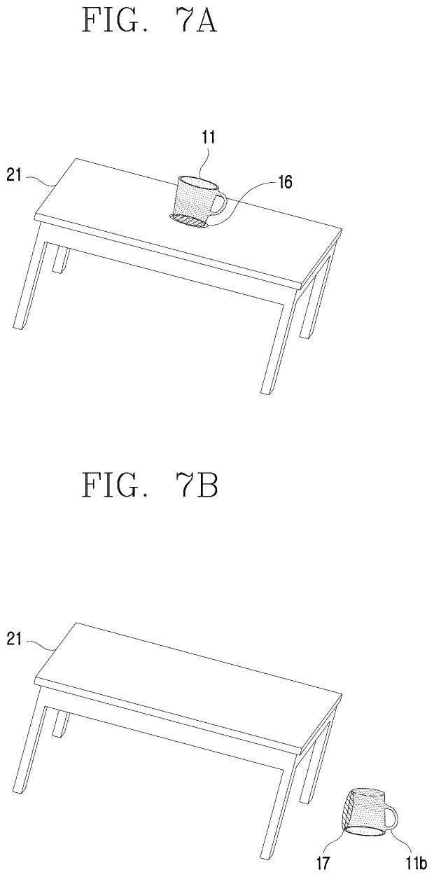

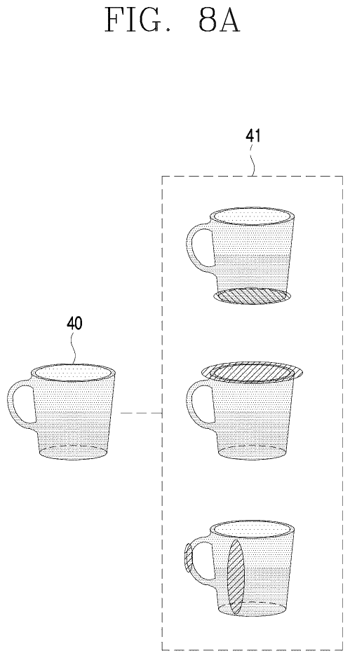

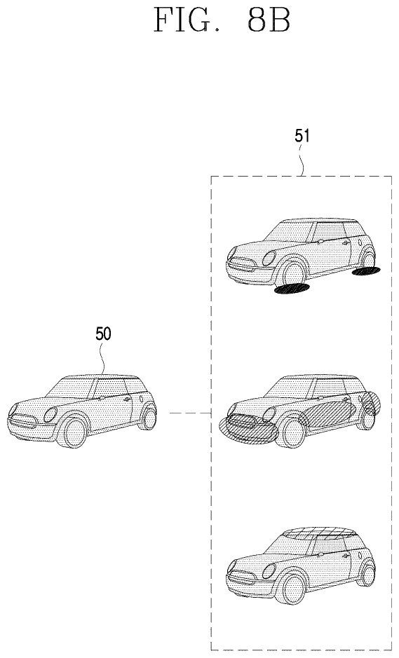

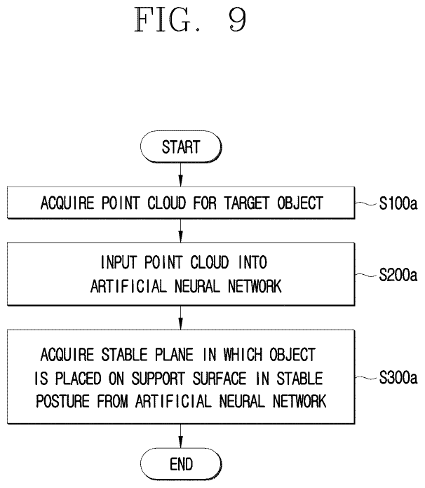

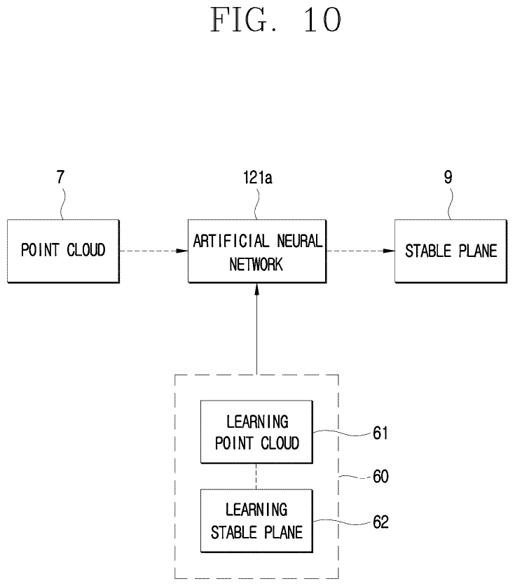

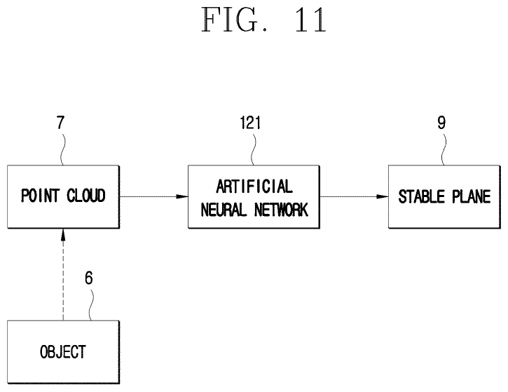

FIG. 2 is a flowchart illustrating the stable plane estimation method for placing an object in a stable posture according to the present invention. FIGS. 3 to 4B illustrate one embodiment of disposing the flat plate model and the mesh in the virtual space. FIGS. 5A and 5B illustrates one embodiment of dropping the mesh toward the flat plate model. FIGS. 6A to 7B illustrate one embodiment of verifying the stable plane. FIGS. 8A and 8B illustrate one embodiment of the stable plane specified for the target object. FIG. 9 is a flowchart illustrating another embodiment of the stable plane estimation method for placing an object in a stable posture according to the present invention. FIG. 10 illustrates one embodiment of training an artificial neural network. FIG. 11 illustrates one embodiment using the artificial neural network.

The stable plane estimation system 100 according to the present invention may dispose the flat plate model, dispose the previously acquired mesh of the target object above the disposed flat plate model, and drop the mesh disposed above the flat plate model toward the flat plate model (S200).

Specifically, the stable plane estimation system 100 may dispose the flat plate model in a transverse direction to a first direction in the virtual space where a physical phenomenon acting in the first direction acts, and dispose the mesh for the target object at a point spaced apart from the flat plate model by a predetermined distance in a direction opposite to the first direction. Referring to FIG. 3, for example, a stable plane estimation system 100 may dispose a flat plate model 20 along a second direction 32 that is a transverse direction of a first direction 31 in the virtual space where a physical phenomenon acting in the first direction 31 acts, and dispose the mesh 10 for the target object at a point spaced apart by a predetermined distance in a third direction 33 that is a direction opposite to the first direction 31 from the previously disposed flat plate model 20.

In this case, the first direction 31 may be a direction corresponding to the direction in which gravity acts in a real space. That is, the physical phenomenon directed toward the first direction 31 may be an interaction that simulates gravity in the real space in the virtual space.

Accordingly, the first direction 31 may be a direction in which the mesh 10 disposed above the flat plate model 20 drops toward the flat plate model.

Moreover, the second direction 32 may be a direction perpendicular to the direction in which gravity acts in the real space, and the third direction 33 may be a direction opposite to the direction in which gravity acts in the real space and may be a direction perpendicular to the second direction 32.

In addition, the flat plate model 20 may be a virtual object on which a plate is disposed in the vertical direction with respect to the direction in which gravity acts in the real space, such as a table, desk, or dining table.

Furthermore, the stable plane estimation system 100 may drop the mesh disposed above the flat plate model in the direction in which the physical phenomenon corresponding to gravity acts in the virtual space.

Referring to FIG. 4A, for example, the stable plane estimation system 100 may drop the mesh 10, which is disposed at a point spaced apart by a predetermined distance along the third direction from the flat plate model 20 disposed in the virtual space, in the first direction toward the flat plate model.

Here, the first direction may be a direction corresponding to the direction in which gravity acts in the real space, and the third direction may be a direction opposite to the direction in which gravity acts in the real space.

Accordingly, the stable plane estimation system 100 may simulate the interaction between the mesh 10 of the target object and the flat plate model 20 based on the physical phenomenon simulated in the virtual space.

Furthermore, the stable plane estimation system 100 may change the posture of the mesh disposed above the flat plate model and repeatedly drop the point cloud toward the flat plate model by a predetermined number of times.

Referring to FIG. 4B, for example, the stable plane estimation system 100 may rotate a mesh 10a by a predetermined angle along at least one 35 of an x-axis, y-axis, and z-axis in the virtual space based on a center point of the mesh 10a.

Accordingly, the stable plane estimation system 100 may drop the mesh 10a rotated along at least one 35 of the x-axis, the y-axis, and the z-axis 35 toward the flat plate model 20, and simulate the interaction between the mesh 10a of the target object and the flat plate model 20 based on the physical phenomenon simulated in the virtual space.

Next, when the simulation of the interaction between the mesh 10a and the flat plate model 20 is completed, the stable plane estimation system 100 may dispose the mesh 10a, which is rotated by a predetermined angle along at least one 35 of the x-axis, the y-axis, and the z-axis from the previously rotated posture of the mesh 10a, above the flat plate model again.

Through this, the stable plane estimation system 100 may drop the mesh 10a disposed again toward the flat plate model 20, and simulate the interaction between the mesh 10a of the target object and the flat plate model 20 based on the physical phenomenon simulated in the virtual space.

Accordingly, the stable plane estimation system 100 may simulate the interaction between the mesh 10a that is disposed in different postures and dropped toward the flat plate model 20 and the flat plate model 20 by repeating the above-described processes by a predetermined number of times.

In one embodiment, the stable plane estimation system 100 may repeatedly rotate the mesh 10a and drop the point cloud 10a toward the flat plate model 20 until the posture of the mesh 10a disposed above the flat plate model 20 is the same as the posture at which the point cloud is initially disposed.

In another embodiment, the stable plane estimation system 100 may generate a random number for at least one 35 of the x-axis, the y-axis, and the z-axis, rotate the mesh 10a based on an angle according to the generated random number, drop the rotated mesh 10a toward the flat plate model 20, and repeatedly perform the above process by a predetermined number of times (for example, 10,000 times).

The stable plane estimation system 100 according to the present invention may sample, as the stable plane, an area in contact with the flat plate model in the mesh when the mesh dropped toward the flat plate model stops, to generate training data for the object controlled to be placed on a specific support surface (S300).

Specifically, the stable plane estimation system 100 may simulate the interaction between the mesh dropped toward the flat plate model and the flat plate model based on the physical phenomenon simulated in the virtual space, and specify, as the stable plane, the area in contact with the flat plate model in the mesh when it is determined that the movement of the mesh has stopped.

For example, for the mesh dropped toward the flat plate model, when the change in the location or posture of the mesh is not detected for a predetermined time interval, the stable plane estimation system 100 may determine that the movement of the mesh has stopped, and specify, as the stable plane, the plurality of vertices (edges and faces) in contact with the flat plate model among the plurality vertices (edges and faces) belonging to the mesh.

Accordingly, in one embodiment, the stable plane estimation system 100 may specify, as a stable plane 16, a plurality of vertices (edges and faces) corresponding to a bottom surface in contact with the flat plate model 20 in the mesh 10 for the cup-shaped target object, as illustrated in FIG. 5A.

In addition, in another embodiment, the stable plane estimation system 100 may specify, as a stable plane 17, an area corresponding to the side surface of the body in contact with the flat plate model 20 in the mesh 10a for the cup-shaped target object, as illustrated in FIG. 5B.

As another example, the stable plane estimation system 100 determines that the movement of the mesh has stopped when the change in the location or the posture of the mesh dropped toward the flat plate model is within a predetermined numerical range during a predetermined time interval, and may specify, as a stable plane, an area in contact with the flat plate model in the mesh.

As another example, when it is recognized that the location of the mesh dropped toward the flat plate model is lower than the flat plate model, the stable plane estimation system 100 may dispose the mesh above the flat plate model again and then drop the mesh disposed again toward the flat plate model.

Furthermore, the stable plane estimation system 100 may specify the stable plane for each of a plurality of meshes disposed at different postures above the flat plate model.

That is, the stable plane estimation system 100 may specify a plurality of stable planes for the mesh of the same target object by specifying the stable plane for each of the plurality of meshes that are repeatedly dropped a predetermined number of times.

Meanwhile, the stable plane estimation system 100 may rotate the flat plate model disposed in the virtual space by a predetermined angle, dispose the mesh above the rotated flat plate model so that the pre-specified stable plane faces the flat plate model, and drop the disposed mesh toward the flat plate model.

With reference to FIGS. 6A and 6B, for example, the stable plane estimation system 100 may rotate a flat plate model 21 by a predetermined angle (for example, 15 degrees) along a longitudinal axis with respect to a fourth direction perpendicular to the first direction in the virtual space, based on the center point of the flat plate model 21. Here, the first direction may be a direction corresponding to the direction in which gravity acts in the real space. Accordingly, the fourth direction may be a second direction perpendicular to the direction in which gravity acts in the real space, or may be another direction perpendicular to each of the first direction and the second direction.

Accordingly, the stable plane estimation system 100 may dispose the meshes 11 and 11a above the rotated flat plate model 21 so that the pre-specified stable planes 16 and 17 faces the flat plate model 21, and drop the disposed meshes 11 and 11a toward the flat plate model 21.

That is, the stable plane estimation system 100 may dispose the meshes 11 and 11a above the rotated flat plate model 21 in the same posture as the posture of the mesh stopped above the flat plate model previously disposed in the upright posture, and drop the disposed meshes 11 and 11a toward the flat plate model 21.

Alternatively, the stable plane estimation system 100 may rotate the posture of the meshes 11 and 11a by the same angle as that of the flat plate model 21 rotated from the posture of the mesh stopped above the flat plate model previously disposed in the upright posture, dispose the meshes 11 and 11a above the flat plate model 21, and drop the disposed meshes 11 and 11a toward the flat plate model 21.

Through this, the stable plane estimation system 100 may simulate the interaction between the meshes 11 and 11a of the target object and the previously rotated flat plate model 21 based on the physical phenomenon simulated in the virtual space.

As another example, the stable plane estimation system 100 may rotate the mesh stopped above the flat plate model according to the interaction simulated in the virtual space previously and the flat plate model together, in a longitudinal axis with respect to the fourth direction perpendicular to the first direction in the virtual space based on the center point of the flat plate model.

To this end, the stable plane estimation system 100 may dispose the mesh above the flat plate model disposed in the virtual space so that the stable plane specified for the mesh is in contact with the mesh, and rotate the flat plate model and the mesh together.

In this case, the stable plane estimation system 100 may temporarily stop the physical phenomenon of the real space simulated in the virtual space during the process of rotating the flat plate model and the mesh, and when the rotation of the flat plate model and the mesh is completed, may simulate the previously stopped physical phenomenon again so that the interaction between the mesh of the previously rotated target object and the flat plate model is simulated.

Furthermore, when the mesh dropped toward the rotated flat plate model stops, the stable plane estimation system 100 may identify the area in contact with the flat plate model in the mesh, compare the identified area with the area specified as the stable plane, and verify the stable plane based on a comparison result.

Referring to FIG. 7A, for example, for the mesh 11 dropped toward the previously rotated flat plate model 21, when the change in the location or posture of the mesh 11 is not detected for a predetermined time interval, the stable plane estimation system 100 may determine that the movement of the mesh 11 is stopped, and identify the area in contact with the flat plate model in the mesh 11.

Accordingly, the stable plane estimation system 100 may compare the area previously with the area specified as the stable plane 16, complete the verification for the pre-specified stable plane 16 when the previously identified area is the same as the area specified as the stable plane 16 according to the comparison result, and remove the information related to the pre-specified stable plane 16 when the previously identified area identified previously is different from the area specified as the stable plane 16 according to the comparison result.

In this case, according to the comparison result, the fact that the previously identified area is the same as the area specified as the stable plane 16 may mean a case where a difference between the previously identified area and the area specified as the stable plane 16 is within a predetermined error margin (for example, 95%) and the fact that the previously identified area is different from the area specified as the stable plane 16 may mean a case where a difference between the previously identified area and the area specified as the stable plane 16 is outside the predetermined error margin.

As another example, for the mesh dropped toward the previously rotated flat plate model, when the change in the location or posture of the mesh is within a predetermined numerical range for a predetermined time interval, the stable plane estimation system 100 may determine that the movement of the mesh is stopped and identify the area in contact with the flat plate model in the mesh.

Accordingly, the stable plane estimation system 100 may compare the previously identified area with the area specified as the stable plane, complete the verification for the pre-specified stable plane when the previously identified area is the same as the area specified as the stable plane according to the comparison result, and remove information related to the pre-specified stable plane when the previously identified area is different from the area specified as the stable plane according to the comparison result.

Referring to FIG. 7B, for another example, when it is recognized that the mesh 11b dropped toward the rotated flat plate model 21 is dropped from the flat plate model 21, the stable plane estimation system 100 may determine that the verification of the stable plane 17 is failed and remove the stable plane 17.

Meanwhile, the stable plane estimation system 100 according to the present invention may label, as label data for the mesh, the pre-specified stable plane.

That is, the stable plane estimation system 100 may rotate the mesh in the virtual space, and label, as the label data, each of the plurality of specified stable planes to the mesh. In this case, the stable plane estimation system 100 may count the number of the plurality of specified stable planes for any one mesh, replicate the mesh based on the counted number, and label each of the plurality of stable planes for each of the plurality of replicated meshes.

Referring to FIG. 8A, for example, the stable plane estimation system 100 may specify a plurality of stable planes 41 corresponding to a bottom surface, an inlet side periphery, a handle, and a side surface, respectively, for a mesh 40 for a cup-shaped target object.

In this case, the stable plane estimation system 100 may label the label data according to the stable plane 41 of each of the bottom surface, the inlet side periphery, the handle, and the side surface, to the mesh 40 for the cup-shaped target object.

Referring to FIG. 8B, as another example, the stable plane estimation system 100 may specify a plurality of stable planes 51 for a mesh 50 for a target object in the shape of a car, and in one embodiment, the plurality of stable planes 51 may include an area corresponding to an area where wheels of the car and a specific support surface are in contact with each other, an area corresponding to side doors, side surfaces of the wheels, and a fender of the car, and an area corresponding to an upper surface of the car.

In this case, the stable plane estimation system 100 may replicate the mesh 50 for the target object in the shape of the car into the plurality of meshes 50 corresponding to the number of plurality of stable planes 51, and label the plurality of label data corresponding to the plurality of stable planes 51 to each of the plurality of meshes 50.

Through this, the stable plane estimation system 100 may generate the training data for the artificial neural network that outputs a stable plane when the point cloud is input, using the mesh and the label data.

Therefore, training data may include the mesh for the target object and the label data labeled in the mesh, and the training data set may be constructed using a plurality of training data trained for different target objects.

That is, the training data set may include the plurality of meshes and the plurality of label data labeled to each of the plurality of meshes.

Additionally, the training data set may include the mesh and label data for each of the plurality of target objects having different shapes.

Through the above configurations, the stable plane estimation system 100 may label, as the label data, each of a plurality of stable planes to each of the plurality of meshes, and construct the training data set using the label data labeled to the plurality of meshes and each of the plurality of meshes.

Meanwhile, when the plurality of stable planes are each specified for the mesh for the specific target object, the stable plane estimation system 100 may specify one or more stable planes having the largest number of points belonging to the stable plane among the plurality of stable planes and determine the one or more stable planes as the stable planes for the corresponding mesh.

In such a case, the stable plane estimation system 100 may label one (or more) stable planes determined in advance for a specific mesh as the label data, and may construct the training data set using the plurality of meshes according to different target objects and the label data labeled for each of the plurality of meshes.

Furthermore, referring to FIG. 9, the stable plane estimation system 100 according to the present invention acquires the point cloud for the object (S100a), inputs the point cloud into the artificial neural network trained using a pre-constructed training data set (S200a), and acquires the stable plane in which the object is placed on a support surface in a stable posture from the artificial neural network (S300a).

Specifically, referring to FIG. 10, when the point cloud 7 for a predetermined object is input using a previously constructed training data set 60, an artificial neural network 121a may be trained to output a stable plane 9 corresponding to the input point cloud 7.

In this case, the artificial neural network 121a may acquire a learning mesh 61 for the target object, drop the learning mesh 61 onto a plane (for example, a plane model), sample an area in contact with the plane in the learning mesh 61 as a learning stable plane 62, and be trained using the training data set 60 including the learning mesh 61 and the learning stable plane 62.

Therefore, referring to FIG. 11, according to an embodiment, the stable plane estimation system 100 may input a point cloud 7 acquired for a specific object 6 based on a depth camera, a server, a point cloud generation device, or the like, into an artificial neural network 121, and acquire a stable plane 9 corresponding to the previously input point cloud 7 from the artificial neural network 121.

Through this, the stable plane estimation system 100 may determine the stable plane 9 for the object 6 corresponding to the previously acquired point cloud 7.

In this regard, when the plurality of stable planes 5 for the specific point cloud 3 are acquired from the artificial neural network 121, the stable plane estimation system 100 may specify one stable plane 5 having the largest number of points belonging to the stable plane 5 among the plurality of stable planes 5 and determine the one stable plane 5 as the stable plane 5 for the target object corresponding to the point cloud 3.

Through the above configurations, the stable plane estimation system 100 according to the present invention can provide one side surface of an object for stably placing various objects in a predetermined space without human manipulation by specifying the stable plane for placing the target object in the stable posture based on the point cloud for the target object.

In addition, the stable plane estimation system 100 according to the present invention can estimate the stable planes for various objects that have not been trained in the past by dropping the meshes for various target objects onto a flat plate model in the virtual space to specify the stable plane, and can also generate large-scale training data for training the artificial neural network.

Through this, the stable plane estimation system 100 according to the present invention can sample the stable plane through a simulation for the target object (or object) whose stable plane has not been trained, and can also estimate the stable plane for the object whose stable plane has not been trained by using the artificial neural network trained with large-scale training data.

That is, the stable plane estimation system 100 can sample the stable plane through simulation for the object including at least one untrained object as the target of manipulation placed on the plane, and through this, can generate training data for at least one untrained object or provide the previously sampled stable plane so that manipulation for placing the object on a plane can be performed.

Here, the term, “untrained” may refer to the absence of reference data for placing an object on a plane in a stable posture, and for example, the at least one untrained object may include an object for which data related to a target posture of the object for placing the object on the plane in a stable posture through the manipulator is not stored. As another example, the at least one untrained object may include a target object for which the artificial neural network trained to output the stable plane corresponding to the object has not been trained.

In addition, the stable plane estimation system 100 according to the present invention can verify whether the stable plane specified for the target object acts as an actual stable plane under various conditions by rotating the flat plate model on which the point cloud is dropped during a simulation process for specifying the stable plane for the target object in the virtual space, and can specify a more accurate stable plane for the target object.

Furthermore, the present invention discussed above may be implemented as a program stored on a computer-readable recording medium that is executed by one or more processors in an electronic device.

Therefore, the present invention may be implemented as a computer-readable code or instruction in a medium in which a program is recorded. In other words, various control methods according to the present invention may be provided in the form of an integrated or individual program.

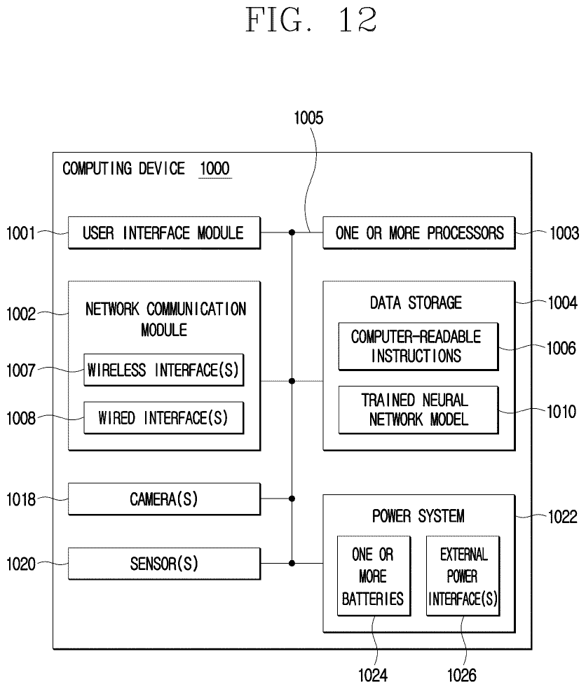

FIG. 12 is a block diagram illustrating a structure of a computing device (or a e electronic device) performing the input-dependent uncorrelated weighting method according to the present invention.

A computing device 1000 may include a user interface module 1001, a network communication module 1002, one or more processors 1003, data storage 1004, one or more camera(s) 1018, one or more sensors 1020, and a power system 1022, all of which may be connected to each other through a system bus, network, or other connection mechanism 1005. The user interface module 1001 may be operable to transmit data to an external user input/output device and/or receive data from the external user input/output device.

For example, in the present invention, receiving the independent image and the correlated image may be performed by external input using the user interface module. In this case, the user interface module 1001 may include a touch screen, a computer mouse, a keyboard, a keypad, a touch pad, a trackball, a joystick, a voice recognition module, or other similar devices.

In addition, the user interface module 1001 may also be constituted to provide output to a user display device, such as one or more cathode ray tubes (CRTs), a liquid crystal display, a light emitting diode (LED), a display using digital light processing (DLP) technology, or a printer. The user interface module 1001 may also be constituted to generate audible output using a device such as a speaker, a speaker jack, an audio output port, an audio output device, earphones, and/or other similar devices.

The user interface module 1001 may further be constituted of one or more tactile devices that may generate a tactile output, such as a vibration and/or other output detectable by touch and/or physical contact with the computing device 1000.

The network communication module 1002 may include one or more devices providing one or more wireless interface(s) 1007 and/or one or more wireline interface(s) 1608 that may be constituted to communicate through a network.

In addition, the network communication module 1002 may be constituted to provide reliable security and/or authenticated communication.

The one or more processors 1003 may include one or more general-purpose processors and/or one or more special-purpose processors (e.g., a digital signal processor, a tensor processing unit (TPU), a graphics processing unit (GPU), a neural network processing unit (NPU), a custom integrated circuit, an application-specific integrated circuit (ASIC), and the like). The one or more processors 1003 may be constituted to execute computer-readable instructions 1006 included in the data storage 1004 and/or other instructions described in the present specification.

As such an example, an algorithm for calculating a denoised pixel estimate at a center pixel described in the present specification and an algorithm for removing noise using the denoised pixel estimate at the center pixel may be performed on a neural network processing unit (NPU) to increase efficiency by performing high-speed data calculation processing with low power.

The data storage 1004 may include one or more non-transitory computer-readable storage media that can be read and/or accessed by at least one of the one or more processors 1003.

The one or more computer-readable storage media may include volatile and/or non-volatile storage constituent elements, such as optical, magnetic, organic, or other memory or disk storage devices. In some examples, the data storage 1004 may be implemented using a single physical device (e.g., one optical, magnetic, organic, or other memory or disk storage device.) In contrast, in other examples, the data storage 1004 may be implemented using two or more physical devices.

The data storage 1004 may include the computer-readable instructions 1006 and additional data. The data storage 1004 may include storage necessary to perform at least some of the methods, scenarios, and techniques described in the present specification and/or at least some of the functions of the devices and networks.

The data storage 1004 may include, for example, storage for a neural network model 1010 to which the algorithm for calculating the denoised pixel estimate at the center pixel described in the present invention and the algorithm for removing noise using the denoised pixel estimate at the center pixel have been applied and which has been trained on the basis of the algorithms.

Meanwhile, the computing device 1000 may include one or more camera(s) 1018, one or more sensors 1020, and/or the power system 1022.

The camera(s) 1018 may capture light and/or electromagnetic radiation emitted as visible light, infrared radiation, ultraviolet light, and/or light of one or more other frequencies. The sensor 1020 may be constituted to measure conditions within the computing device 1000 and/or conditions in the environment of the computing device 1000 and provide data about those conditions. The power system 1022 may include one or more batteries 1024 and/or one or more external power interfaces 1026 for providing power to the computing device 1000.

Meanwhile, while the above has described that the system performing the input-dependent uncorrelated weighting method according to the present invention is implemented as a computing device, the present invention is not limited thereto. For example, the functions of the neural network and/or the computing device may be distributed among a plurality of computing clusters.

Meanwhile, the present invention described above may be executed by one or more processes on a computer and implemented as a program that can be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMS, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present disclosure should be determined based on the reasonable interpretation of the appended claims, and all of the modifications within the equivalent scope of the present disclosure belong to the scope of the present disclosure.

What is claimed is:

1. A stable plane estimation method for placing an object in a stable posture, the stable plane estimation method comprising:
acquiring a mesh for a target object;
disposing a flat plate model, disposing the mesh above the flat plate model, and dropping the mesh disposed above the flat plate model toward the flat plate model; and
sampling, as a stable plane, an area in contact with the flat plate model in the mesh when the mesh dropped toward the flat plate model stops, to generate training data for an object controlled to be placed on a specific support surface.

2. The stable plane estimation method of claim 1, further comprising:
rotating the flat plate model disposed in a virtual space by a predetermined angle, disposing the mesh so that the sampled stable plane faces the flat plate model from above the rotated flat plate model, and dropping the disposed mesh toward the flat plate model;
identifying the area in contact with the flat plate model in the mesh when the mesh that has been dropped toward the rotated flat plate model stops; and
comparing the identified area with the area sampled as the stable plane, and verifying the stable plane based on a comparison result.

3. The stable plane estimation method of claim 1, wherein the object includes at least one untrained object as a target of manipulation placed on a plane.

4. The stable plane estimation method of claim 1, wherein the dropping of the mesh toward the flat plate model includes changing a posture of the mesh disposed above the flat plate model and repeatedly dropping the point cloud toward the flat plate model by a predetermined number of times, and
the sampling the plurality of points as the stable plane includes sampling the stable plane for each of the plurality of areas dropped repeatedly by a predetermined number of times.

5. The stable plane estimation method of claim 1, further comprising:
labeling, as label data for the mesh, the sampled stable plane to the mesh; and
generating the training data for an artificial neural network that outputs the stable plane when the point cloud corresponding to the target object is input, using the mesh and the label data.

6. A stable plane estimation system for placing an object in a stable posture, the stable plane estimation system comprising:
an input unit configured to acquire a mesh for a target object; and
a control unit configured to dispose a flat plate model, dispose the mesh above the flat plate model, and drop the mesh disposed above the flat plate model toward the flat plate model,
wherein the control unit samples, as a stable plane, an area in contact with the flat plate model in the mesh when the mesh dropped toward the flat plate model stops, to generate training data for an object controlled to be placed on a specific support surface.

7. A program stored on a computer-readable recording medium, and executed by one or more processors in an electronic device, the program including instructions to execute:
acquiring a mesh for a target object;
disposing a flat plate model, disposing the mesh above the flat plate model, and dropping the mesh disposed above the flat plate model toward the flat plate model; and
sampling, as a stable plane, an area in contact with the flat plate model in the mesh when the mesh dropped toward the flat plate model stops, to generate training data for an object controlled to be placed on a specific support surface.

8. A stable plane estimation method for placing an object in a stable posture, the stable plane estimation method comprising:
acquiring a point cloud for an object;
inputting the point cloud into an artificial neural network trained using a pre-constructed training data set; and
acquiring a stable plane in which the object is placed on a support surface in a stable posture from the artificial neural network,
wherein the trained artificial neural network
acquires a learning mesh for a target object, drops the learning mesh onto a plane, samples an area in contact with the plane in the learning mesh as a learning stable plane, and is trained using the training data set including the learning mesh and the learning stable plane.

9. A stable plane estimation system for placing an object in a stable posture, the stable plane estimation system comprising:
an input unit configured to acquire a point cloud for an object; and
a control unit configured input the point cloud into an artificial neural network trained using a pre-constructed training data set and acquire a stable plane in which the object is placed on a support surface in a stable posture from the artificial neural network, wherein the trained artificial neural network acquires a learning mesh for a target object, drops the learning mesh onto a plane, samples an area in contact with the plane in the learning mesh as a learning stable plane, and is trained using the training data set including the learning mesh and the learning stable plane.

10. A program stored on a computer-readable recording medium, and executed by one or more processors in an electronic device, the program including instructions to execute:
acquiring a point cloud for an object;
inputting the point cloud into an artificial neural network trained using a pre-constructed training data set; and
acquiring a stable plane in which the object is placed on a support surface in a stable posture from the artificial neural network,
wherein the trained artificial neural network
acquires a learning mesh for a target object, drops the learning mesh onto a plane, samples an area in contact with the plane in the learning mesh as a learning stable plane, and is trained using the training data set including the learning mesh and the learning stable plane.
